(19) United States
(12) Patent Application Publication
(10) Pub. No.: US 2016/0092007 A1
(43) Pub. Date: Mar. 31, 2016

(54) TOUCH PANEL CONTROLLER, INTEGRATED CIRCUIT, AND ELECTRONIC DEVICE

(71) Applicant: SHARP KABUSHIKI KAISHA, Osaka-shi, Osaka (JP)

(72) Inventor: Yusuke KANAZAWA, Osaka-shi (JP)

(73) Assignee: SHARP KABUSHIKI KAISHA, Osaka-shi, Osaka (JP)

(21) Appl. No.: 14/892,005

(22) PCT Filed: Apr. 24, 2014
(86) PCT No.: PCT/JP2014/061555

§ 371 Date: Nov. 18, 2015

(30) Foreign Application Priority Data
Jun. 24, 2013 (JP) 2013-132048

(51) Int. Cl. G06F 3/044; G06F 3/041

(52) U.S. Cl. CPC G06F 3/044; G06F 3/0416

(57) ABSTRACT

A driving unit (14) applies a driving voltage based on a predetermined code sequence to each of a plurality of drive lines, and thereby an integration circuit (21) outputs a linear sum signal based on a linear sum of amounts of charges accumulated in a sense line. This is performed a plurality of times, and a computation unit (23) estimates an electrostatic capacitance. The driving unit (14) applies a positive driving voltage and a negative driving voltage to a pair of adjacent drive lines.

### TECHNICAL FIELD

The present invention relates to a touch panel controller which controls a touch panel, an integrated circuit, and an electronic device.

### BACKGROUND ART

A touch panel device is a pointing device which detects a position on a touch panel, with or to which an object such as a finger of a user or a pen point of a stylus pen (hereinafter, referred to as an “indicator”) is in contact or proximate (hereinafter, referred to as a “touch”), and outputs information of the detected position. By providing the touch panel on a display screen of a display device, the touch panel device allows an intuitive operation compared to an input device such as a keyboard or a mouse. Thus, it is prominent to be mounted, for example, in a mobile phone, a smartphone, a tablet terminal and the like.

Among the touch panel devices described above, a projected capacitive touch panel device has been widely used in recent years from a viewpoint of a transmittance, durability and the like. In the case of the projected capacitive touch panel device, the touch panel has transparent electrode patterns such as ITO (Indium Tin Oxide) formed in a grid pattern on a transparent substrate made of glass, plastic or the like. When an indicator touches the touch panel, electrostatic capacitances in a plurality of transparent electrode patterns in a vicinity thereof change (for example, decrease). Accordingly, by detecting a change in a current or a voltage of the transparent electrode patterns, it is possible to detect a position touched by the indicator.

### (Configuration Example of Conventional Technique)

As one example of a conventional projected capacitive touch panel device, there is a touch panel system which drives a plurality of drive lines in parallel and estimates an electrostatic capacitance, which is disclosed in PTL 1. FIG. 6 is a circuit diagram illustrating a schematic configuration of the touch panel system.

As illustrated in FIG. 6, a touch panel system 1011 described in PTL 1 is configured to include a touch panel 1012 and a touch panel controller 1013. The touch panel 1012 includes drive lines DL1 to DL4 and sense lines SL1 to SL4. Thereby, the drive lines DL1 to DL4 and the sense lines SL1 to SL4 have electrostatic capacitances C11 to C44 at positions where they intersect with each other (hereinafter, referred to as “intersections”).

The touch panel controller 1013 includes a driving unit 1014 which drives the drive lines DL1 to DL4. The driving unit 1014 applies a voltage (hereinafter, referred to as a “driving voltage”) based on predetermined code sequences to each of the drive lines DL1 to DL4. At this time, with existence of the electrostatic capacitances C11 to C44, a current flows through the sense lines SL1 to SL4 and charges are accumulated in the intersections.

The touch panel controller 1013 includes a detection unit 1015 which detects signals from the sense lines SL1 to SL4. Specifically, the detection unit 1015 includes a plurality of integration circuits 1021 each using an operational amplifier 1024 and a capacitor having an integration capacitance Cint, and each of the plurality of integration circuits 1021 is connected to each of the sense lines SL1 to SL4. Thereby, an output voltage of each of the integration circuits 1021 connected to each of the sense lines SL1 to SL4 serves as a voltage in proportion to an integration value of the current flowing through the sense lines, that is, a voltage in proportion to a linear sum (total sum) of amounts of charges which are respectively accumulated in a plurality of intersections in the sense lines (linear sum signal).

### (Operation Example of Conventional Technique)

An operation example of the touch panel system 1011 which is configured as described above will be described. Note that, description will be given by focusing on the sense line SL3 among the sense lines SL1 to SL4 in the operation example.

FIG. 7 is a view indicating one example of the aforementioned code sequences used in the driving unit 1014 in a tabular form. Code sequences MC1 which are indicated in the figure are based on M-sequences, and elements of the code sequences MC1 are either “1” or “−1”. For example, the driving unit 1014 drives the drive lines DL1 to DL4 illustrated in FIG. 6 by using code sequences of column vectors Drive 1 to Drive 4 in the code sequences MC1 indicated in FIG. 7. In addition, the driving unit 1014 applies a driving voltage of Vdrive when an element of the code sequences is “1”, and applies a driving voltage of −Vdrive when the element is “−1”. Note that, as the driving voltage, a power supply voltage may be used or a voltage other than the power supply voltage, such as a reference voltage, may be used.

First, based on elements of the column vectors Drive 1 to Drive 4 in a first row vector (1st Vector) of the code sequences MC1 indicated in FIG. 7, the driving voltage of Vdrive is applied to the drive lines DL1, DL3 and DL4 and the driving voltage of −Vdrive is applied to the drive line DL2. In this case, amounts of charges of “C31×Vdrive”, “C32×(−Vdrive)”, “C33×Vdrive”, and “C34×Vdrive” are to be respectively accumulated at the intersections of the sense line SL3 and the drive lines DL1 to DL4. Accordingly, an amount of charges Q3 accumulated in the sense line SL3 is provided by a following formula.

Q3=C31×Vdrive+C32×(−Vdrive)+C33×Vdrive+C34×Vdrive=Vdrive×(C31−C32+C33+C34) (1).

Then, an output voltage Y3 of the integration circuit 1021 which is connected to the sense line SL3 is provided by a following formula.

Y3=(time integration of the current flowing through the sense line SL3)/Cint=Q3/Cint (2).

Here, Cint is an integration capacitance in the integration circuit 1021.

Next, a driving voltage based on a second row vector (2nd Vector) of the code sequences MC1 is applied to the drive lines DL1 to DL4 and the output voltage Y3 of the integration circuit 1021 which is connected to the sense line SL3 is detected, and the similar will be repeated thereafter. Thereby, thirty one output voltages Y3 are to be detected. By calculating an inner product of the thirty one output voltages Y3 and a decoded matrix of the code sequences MC1 indicated in FIG. 7, each of the electrostatic capacitances C31 to C34 at intersections on the sense line SL3 is able to be estimated.

FIG. 8 is a circuit diagram illustrating a schematic configuration of another touch panel system described in PTL 1. A touch panel system 1111 illustrated in FIG. 8 is different from the touch panel system 1011 illustrated in FIG. 6 in that one differential amplifier 1124 is provided instead of the two operational amplifier 1024 in the integration circuits connected to a pair of adjacent sense lines, and is similar in other configurations.

In this case, for example, when the driving voltage based on the first row vector of the code sequences MC1 indicated in FIG. 7 is applied to the drive lines DL1 to DL4, an output voltage Y34 of the differential amplifier 1124 which is connected to the sense lines SL3 and SL4 is provided by a following formula. Usage of the differential amplifier 1124 allows increasing a dynamic range and removing a common mode noise.

Y34=Y3−Y4=(Vdrive/Cint)×{(C31−C41)−(C32−C42)+(C33−C43)+(C34−C44)} (3).

### CITATION LIST

### Patent Literature

PTL 1: Japanese Unexamined Patent Application Publication No. 2013-3603 (Published on Jan. 7, 2013)

### SUMMARY OF INVENTION

### Technical Problem

The respective sense lines SL1 to SL4 have parasitic capacitances such as electrostatic capacitances with respect to a ground, in addition to the electrostatic capacitances C11 to C44 with respect to the drive lines DL1 to DL4 at the intersections. Therefore, when the driving voltage is applied to the drive lines DL1 to DL4, charges are to be accumulated in the sense lines SL1 to SL4 by an amount of the parasitic capacitances. Accordingly, it is desired to consider the parasitic capacitances in order to estimate the electrostatic capacitances C11 to C44.

Here, when the parasitic capacitances of the pair of adjacent sense lines SL3 and SL4 are equal, amounts of charges accumulated due to the parasitic capacitances are equal, so that influence due to the parasitic capacitances on an output voltage of the differential amplifier 1124 is suppressed by using the differential amplifier 1124 illustrated in FIG. 8. When the parasitic capacitances of the sense lines SL3 and SL4 are different, however, the amounts of charges accumulated due to the parasitic capacitances are different, so that the differential amplifier 1124 performs amplification by amount of the difference of the parasitic capacitances and accuracy of estimation values of the electrostatic capacitances C11 to C44 are deteriorated.

The invention has been made in view of the aforementioned problem and an object thereof is to provide, for example, a touch panel controller capable of accurately estimating an amount of changes in electrostatic capacitances.

### Solution to Problem

A touch panel controller according to the invention is a touch panel controller which controls a touch panel having M (M is an integer of 2 or more) electrostatic capacitances formed between M drive lines and a sense line, including: a driving unit which performs N (N is an integer) time of driving for applying a driving voltage based on a predetermined code sequence represented by N K-dimensional vector to one drive line of each of K (K is an integer and satisfies 1≦K≦M/2) pair of drive lines and applying a driving voltage obtained by inverting a polarity of the driving voltage to the other drive line of each pair; and a detection unit which detects a linear sum of amounts of charges accumulated in the sense line by the driving voltages and the electrostatic capacitances and outputs a linear sum signal based on the linear sum N time, in order to solve the aforementioned problem.

### Effects of Invention

According to one aspect of the invention, an effect of capable of accurately estimating an amount of changes in electrostatic capacitances is achieved.

### BRIEF DESCRIPTION OF DRAWINGS

FIG. 1 is a circuit diagram illustrating a schematic configuration of a touch panel device according to a first embodiment of the invention.

FIG. 2 is a circuit diagram illustrating the touch panel device in a simplified manner.

FIG. 3 is a graph indicating one example of estimation values of capacitances calculated when there is a touch input in a vicinity of an intersection of a certain sense line and a certain drive line in the touch panel device.

FIG. 4 is a graph indicating one example of estimation values of capacitances calculated when there are touch inputs in a vicinity of an intersection of a certain sense line and a certain drive line and in a vicinity of an intersection of the sense line and a different drive line in a touch panel device according to a second embodiment of the invention.

FIG. 5 is a block diagram illustrating a schematic configuration of a mobile phone according to a third embodiment of the invention.

FIG. 6 is a circuit diagram illustrating a schematic configuration of a conventional touch panel system.

FIG. 7 is a view indicating one example of code sequences used in a driving unit of the touch panel system in a tabular form.

FIG. 8 is a circuit diagram illustrating a schematic configuration of another conventional touch panel system.

### DESCRIPTION OF EMBODIMENTS

### Embodiment 1

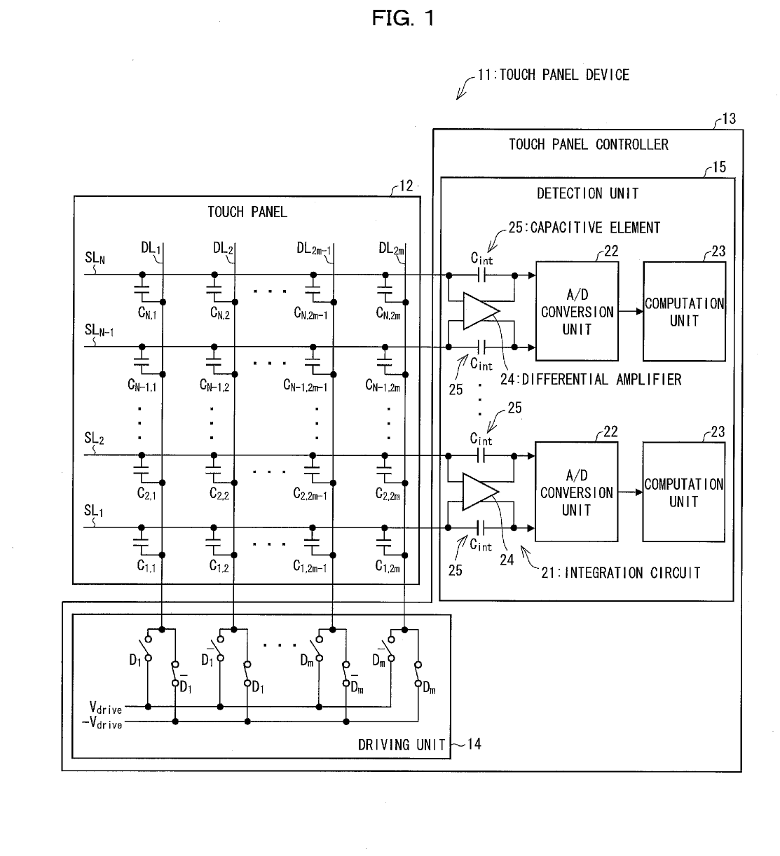

One embodiment of the invention will be described below with reference to FIG. 1 to FIG. 3. Note that, for convenience of description, the same reference signs are assigned to members having the same functions as those of members indicated in each of embodiments, and description thereof will be omitted as appropriate.

### (Configuration of Touch Panel Device)

FIG. 1 is a circuit diagram illustrating a schematic configuration of a touch panel device according to the present embodiment. As illustrated in the figure, a touch panel device (electronic device) 11 is composed to include a touch panel 12 and a touch panel controller 13. The touch panel 12 includes 2 m (M) drive lines DL1 to DL2m and N sense lines SL1 to SLN (m, and N are natural numbers). The drive lines DL1 to DL2m and the sense lines SL1 to SLN are arranged to be orthogonal to each other, and thereby have electrostatic capacitances C1,1 to CN,2m at intersections which are arranged in a matrix manner.

The touch panel controller 13 includes a driving unit 14 which drives the drive lines DL1 to DL2m, and a detection unit 15 which detects signals from the sense lines SL1 to SLN. The driving unit 14 applies a driving voltage based on predetermined code sequences, which mutually have low correlation, to each of the drive lines DL1 to DL2m. At this time, with existence of the electrostatic capacitances C1,1 to CN,2m, a current flows through the sense lines SL1 to SLN and charges are accumulated in the intersections.

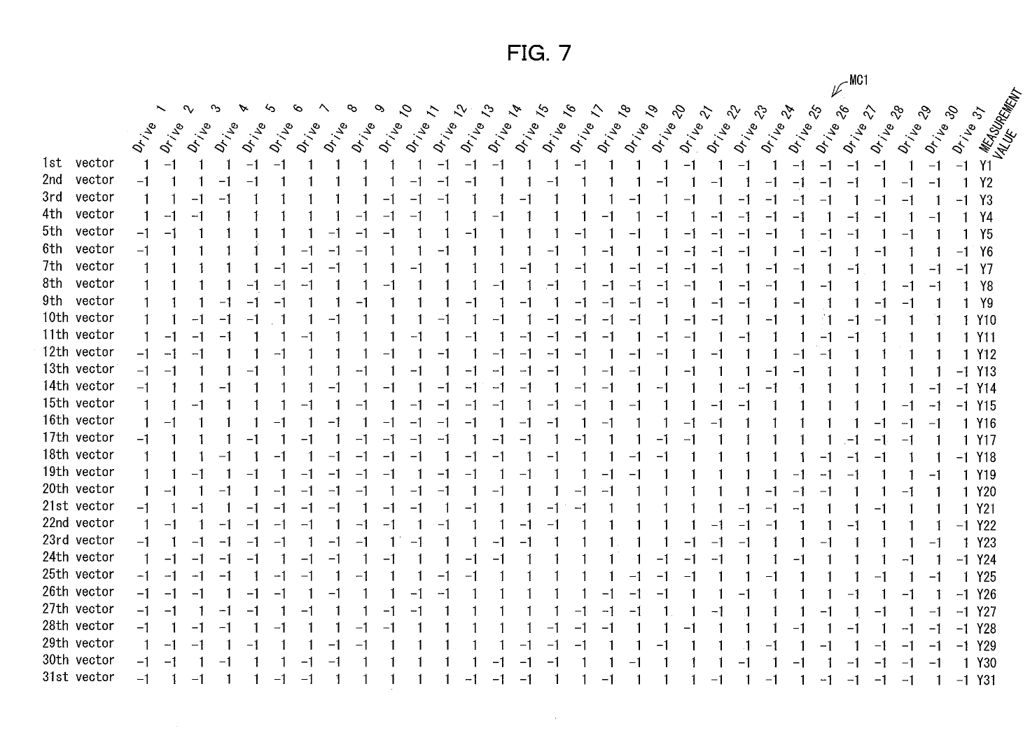

Specifically, the driving unit 14 uses the code sequences MC1 indicated in FIG. 7 as the code sequences and associates the drive lines DL1 to DL2m with each of 2M column vectors (for example, Drive 1 to Drive 2m) in the code sequences. Then, the driving unit 14 applies a driving voltage corresponding to an element of the 2M column vectors in an i-th row vector of the code sequences in i-th driving. That is, the driving unit 14 applies the driving voltage of Vdrive when the element is “1” and applies the driving voltage of −Vdrive when the element is “−1”.

In the detection unit 15, an integration circuit 21, an A/D conversion unit 22 and a computation unit (estimation unit) 23 are provided for each of a pair of adjacent sense lines.

The integration circuit 21 includes one differential amplifier 24 and two capacitive elements (for example, capacitors) 25 having an integration capacitance Cint. The differential amplifier 24 is of a fully-differential two-input-two-output type, and two input signals are respectively input thereto from the pair of sense lines, and two differential signals which have been differentially amplified are respectively fed back through the two capacitive elements 25. Thereby, output voltages of the two differential signals become voltages in proportion to a difference between integration values of currents flowing through each of the pair of sense lines, that is, voltages in proportion to a difference between a linear sum of amounts of charges respectively accumulated in a plurality of intersections of one of the pair of sense lines and a linear sum of amounts of charges respectively accumulated in a plurality of intersections of the other of the pair of sense lines.

The two differential signals which have been differentially amplified by the differential amplifier 24 are converted into digital signals by the A/D conversion unit 22 and subjected to computation by the computation unit 23, and then relative values of the electrostatic capacitances C1,1 to CN,2m at the intersections are estimated.

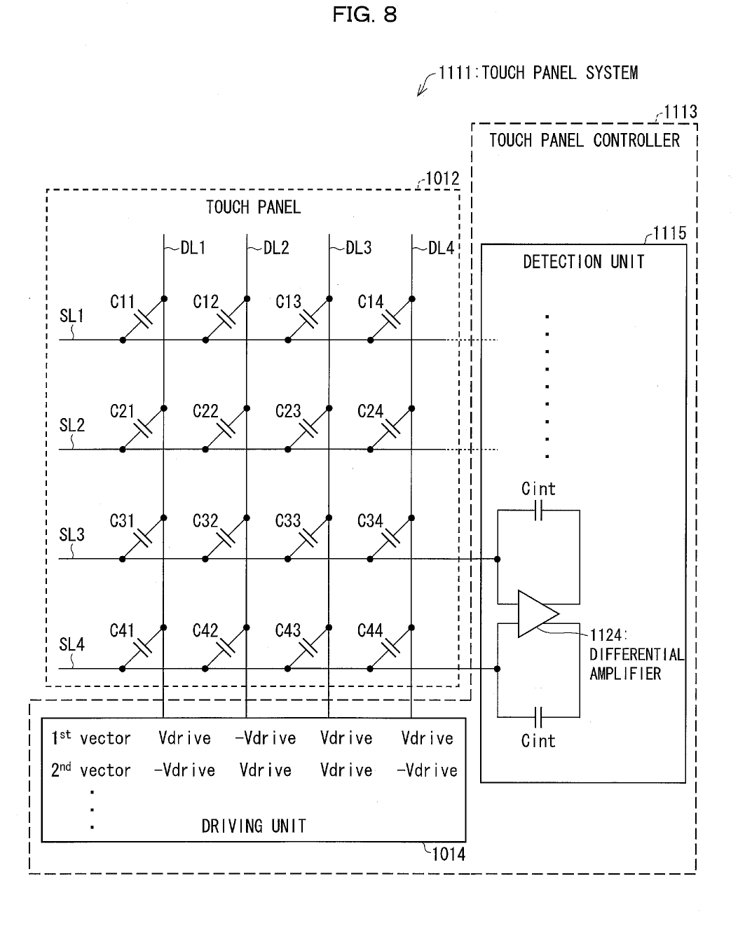

The configuration above is different from a configuration of the conventional touch panel system 1111 illustrated in FIG. 8 in the numbers of drive lines and sense lines, and others are similar thereto.

### (Details of Computation Unit)

Next, details of computation in the computation unit 23 will be described. Note that, each of the numbers of drive lines and sense lines is set as four, which is the same as that in FIG. 8, for simplifying description.

When a driving voltage based on an i-th row vector (i th Vector) (i is an integer of 1 to 31) in the code sequences indicated in FIG. 7 is applied to the drive lines DL1 to DL4, an output voltage Y34i of the integration circuit 21 connected to the pair of sense lines SL3 and SL4 is provided by a following formula. Here, Di1 to Di4 represent elements (1 or −1) of the i-th row vector in the code sequences of the column vectors Drive 1 to Drive 4 among the code sequences indicated in FIG. 7.

Y34i=Y3i−Y4i=(Vdrive/Cint)×(Di1×(C31−C41)+Di2×(C32−C42)+Di3×(C33−C43)+Di4×(C34−C44)) (4).

By iterating the operation as described above also for other row vectors, thirty-one output voltages Y34,1 to Y34,31 are detected.

Next, in order to estimate, for example, a difference between electrostatic capacitances (C31−C41) by the drive line DL1 an inner product of the thirty-one output voltages Y34,1 to Y34,31 and the elements D1,1 to D31,1 of the column vector Drive 1 corresponding to the drive line DL1 is obtained. In this case, the formula (4) becomes a following formula.

$$\begin{matrix} [ Expression 1 ] & \\ {\sum }_{i = 1}^{31} ( Y {3}_{i} - Y {4}_{i} ) {D}_{i 1} = {\sum }_{i = 1}^{31} ( \frac{{V}_{drive}}{{C}_{int}} [ {D}_{i 1} ( {C}_{31} - {C}_{41} ) + {D}_{i 2} ( {C}_{32} - {C}_{42} ) + {D}_{i 3} ( {C}_{33} - {C}_{43} ) + {D}_{i 4} ( {C}_{34} - {C}_{44} ) ] {D}_{i 1} ) & ( 5 )\end{matrix}$$

Meanwhile, it is known that an inner product of the same sequences takes the same value as a sequence length and an inner product of different sequences takes a value of −1 in the case of an M-sequence. Accordingly, the formula (5) becomes as follows.

$$\begin{matrix} [ Expression 2 ] & \\ {\sum }_{i = 1}^{31} ( Y {3}_{i} - Y {4}_{i} ) {D}_{i 1} = \frac{{V}_{drive}}{{C}_{int}} [ 31 ( {C}_{31} - {C}_{41} ) - ( {C}_{32} - {C}_{42} ) - ( {C}_{33} - {C}_{43} ) - ( {C}_{34} - {C}_{44} ) ] & ( 6 )\end{matrix}$$

Here, when it is assumed that all the sense lines SL1 to 4 are created with a uniform width and all the drive lines DL1 to DL4 are created with a uniform width, the electrostatic capacitances C11 to C44 at the intersections are at the same degree (same order) when no touch is performed. Accordingly, the formula (6) is able to be approximated as a following formula.

$$\begin{matrix}[ Expression 3 ] & \\ {\sum }_{i = 1}^{31} ( Y {3}_{i} - Y {4}_{i} ) {D}_{i 1} \approx \frac{{V}_{drive}}{{C}_{int}} [ 31 ( {C}_{31} - {C}_{41} ) ] & ( 7 )\end{matrix}$$

Thus, from the inner product of the thirty-one output voltages Y34,1 to Y34,31 and the elements D1,1 to D31,1 of the column vector Drive 1 corresponding to the drive line DL1, the difference of the electrostatic capacitances (C31−C41) is able to be estimated. By performing the similar also for other drive lines DL2 to DL4, differences of other electrostatic capacitances (C32−C42), (C33−C43) and (C34−C44) are able to be estimated.

### (About Parasitic Capacitance)

Next, a case where each sense line has a parasitic capacitance will be described. In the differential amplifier 24, input voltages X3i and X4i of two input signals from the pair of sense lines SL3 and SL4 are provide by a following formula. Here, Vcm represents a common mode voltage.

$$\begin{matrix}[ Expression 4 ] & \\ \{ \begin{matrix}X {3}_{i} = \frac{- {V}_{drive} [ \begin{matrix}{D}_{i 1} ( {C}_{31} + {C}_{41} ) + {D}_{i 2} ( {C}_{32} + {C}_{42} ) + \\ {D}_{i 3} ( {C}_{33} + {C}_{43} ) + {D}_{i 4} ( {C}_{34} + {C}_{44} )\end{matrix} ]}{2 ( {C}_{31} + {C}_{32} + {C}_{33} + {C}_{34} + {C}_{int} )} + {V}_{cm} \\ X {4}_{i} = \frac{- {V}_{drive} [ \begin{matrix}{D}_{i 1} ( {C}_{31} + {C}_{41} ) + {D}_{i 2} ( {C}_{32} + {C}_{42} ) + \\ {D}_{i 3} ( {C}_{33} + {C}_{43} ) + {D}_{i 4} ( {C}_{34} + {C}_{44} )\end{matrix} ]}{2 ( {C}_{41} + {C}_{42} + {C}_{43} + {C}_{44} + {C}_{int} )} + {V}_{cm}\end{matrix} & ( 8 )\end{matrix}$$

As described above, when it is set that the electrostatic capacitances C11 to C44 at the intersections are at the same degree when no touch is performed and are able to be approximated with an electrostatic capacitance Cx, the formula (8) is able to be approximated as a following formula.

$$\begin{matrix}[ Expression 5 ] & \\ \{ \begin{matrix}X {3}_{i} \approx \frac{- {V}_{drive} {C}_{x} [ {D}_{i 1} + {D}_{i 2} + {D}_{i 3} + {D}_{i 4} ]}{( 4 {C}_{x} + {C}_{int} )} + {V}_{cm} \\ X {4}_{i} \approx \frac{- {V}_{drive} {C}_{x} [ {D}_{i 1} + {D}_{i 2} + {D}_{i 3} + {D}_{i 4} ]}{( 4 {C}_{x} + {C}_{int} )} + {V}_{cm}\end{matrix} & ( 9 )\end{matrix}$$

Thus, the input voltages X3i and X4i depend on a total value of the elements Di1, Di2, Di3 and Di4 of the code sequences corresponding to driving of the respective drive lines DL1 to DL4. Plainly to say, the input voltages X3i and X4i depend on driving patterns of the respective drive lines DL1 to DL4.

Here, a parasitic capacitance of the sense line SL3 is set as Cp3 and a parasitic capacitance of the sense line SL4 is set as Cp4. When the two parasitic capacitances Cp3 and Cp4 are equal, the input voltages X3i and X4i are also equal according to the formula (9), so that amounts of charges respectively accumulated in the sense lines SL3 and SL4 by the parasitic capacitances Cp3 and Cp4 become equal. Thus, in the output voltage Y34,i of the differential amplifier 24, influence by the parasitic capacitances Cp3 and Cp4 is suppressed.

When the two parasitic capacitances Cp3 and Cp4 are different, however, the amounts of charges respectively accumulated in the sense lines SL3 and SL4 by the parasitic capacitances Cp3 and Cp4 are different, so that amplification is performed by an amount of the difference between the parasitic capacitances Cp3 and Cp4 by the differential amplifier 24, resulting that accuracy of estimation values of the electrostatic capacitances C11 to C44 is deteriorated.

### (Details of Driving Unit)

Thus, in the present embodiment, the driving unit 14 uses each element Dij of the code sequences for an odd-numbered drive line DL2j-i (j is an integer of 1 to M) and uses an element −Dij obtained by inverting a positive or negative sign (polarity) of the element Dij (hereinafter referred to as an “inversion element”) for an even-numbered drive line DL2j, as illustrated in FIG. 1.

Though the input voltages X3i and X4i of the differential amplifier 24 depend on a total value of elements Di,1 to Di,2m of the code sequences corresponding to driving of the respective drive lines DL1 to DL2m like the formula (9), the total value becomes zero in the case of the present embodiment. Accordingly, even when the parasitic capacitances Cp3 and Cp4 of the pair of sense lines SL3 and SL4 are different (exist), an approximate value of the input voltages X3i and X4i of the differential amplifier 24 becomes zero and an approximate value of the amounts of charges respectively accumulated in the sense lines SL3 and SL4 by the parasitic capacitances Cp3 and Cp4 also becomes zero and equal thereto. Thus, in the output voltage Y34,i of the differential amplifier 24, influence by the parasitic capacitances Cp3 and Cp4 is suppressed.

### (Example)

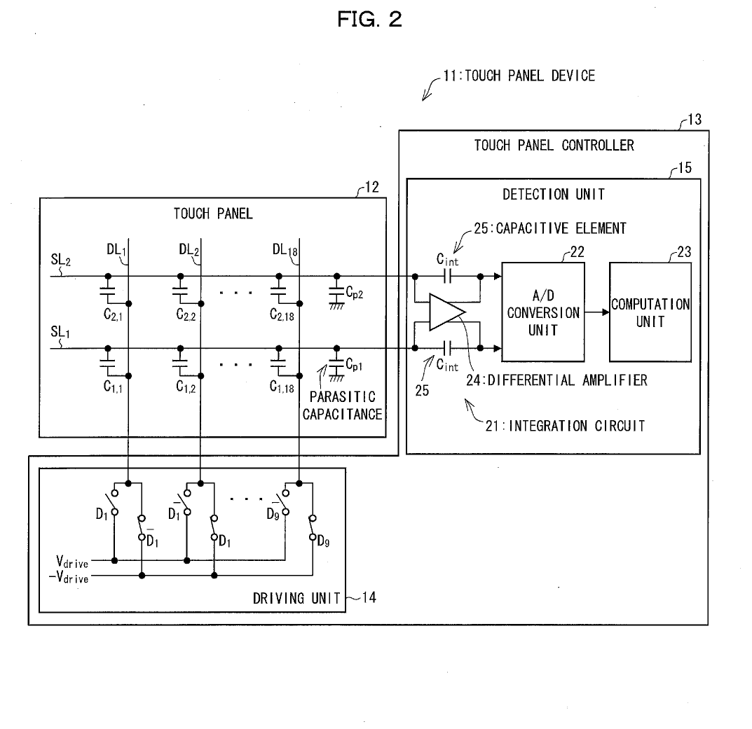

Next, description will be given for an example of the touch panel device 11 which is configured as described above. For convenience of the description, FIG. 2 is a circuit diagram illustrating the touch panel device 11, which is illustrated in FIG. 1, in a simplified manner. In the touch panel device 11 illustrated in FIG. 2, the touch panel 12 includes two sense lines SL1 and SL2 and eighteen drive lines DL1 to DL18 which intersect with the sense lines SL1 and SL2.

All electrostatic capacitances C1,1 to C2,18 at the intersections had 2.2 pF, and the integration capacitance Cint of the integration circuit 21 had 8 pF. When a touch is performed, the electrostatic capacitance C1,1 to C2,18 at a touched portion was set to decrease by 0.2 pF. Moreover, a parasitic capacitance Cp1 of the sense line SL1 had 9 pF and a parasitic capacitance Cp2 of the sense line SL2 had 11 pF. A clock signal with 1 MHz was used and a cycle of driving in the driving unit 14 was 1μ second. A power supply voltage VDD was 3.3 V and a common mode voltage Vcm was 1.65 V. The driving voltage was VDD/2+Vcm=3.3V when an element of the code sequences was “1” and the driving voltage was −VDD/2+Vcm=0V when the element was “−1”.

In the present operation example, sixty-three M-sequences generated by bit-shifting M-sequences having a length of arrays of 63 were used as the code sequences and elements of the code sequences were DMt,1 to DMt,63. The elements DMt,1 to DMt,63 were changed for each clock, and, for example, changed to DM1,1 to DM1,63 in a first clock and changed to DM63,1 to DM63,63 in a sixty-third clock. Then, they were returned again to DM1,1 to DM1,63 which are the same values as those of the first clock, and the same values were iterated for every sixty-three clocks.

The driving unit 14 applied a driving voltage corresponding to elements DMt,1 to DMt,9 of the code sequences to the odd-numbered drive lines DL1 to DL17, respectively. On the other hand, the driving unit 14 applied a driving voltage (inversion voltage) corresponding to inversion elements −DMt,1 to −DMt,9 of the elements DMt,1 to DMt,9 to the even-numbered drive lines DL2 to DL18, respectively. Thereby, the differential amplifier 24 connected to the sense lines SL1 and SL2 output an output voltage Y12,t. The processing above was iterated from t=1 to t=63.

The computation unit 23 calculated an inner product of detected output voltages Y12,1 to Y12,63 and elements DM1,j to DM63,j of a code sequence corresponding to a drive line DLj, and estimates a difference of electrostatic capacitances C1,j−C2,j at an intersection of the drive line DLj by using the formula (7).

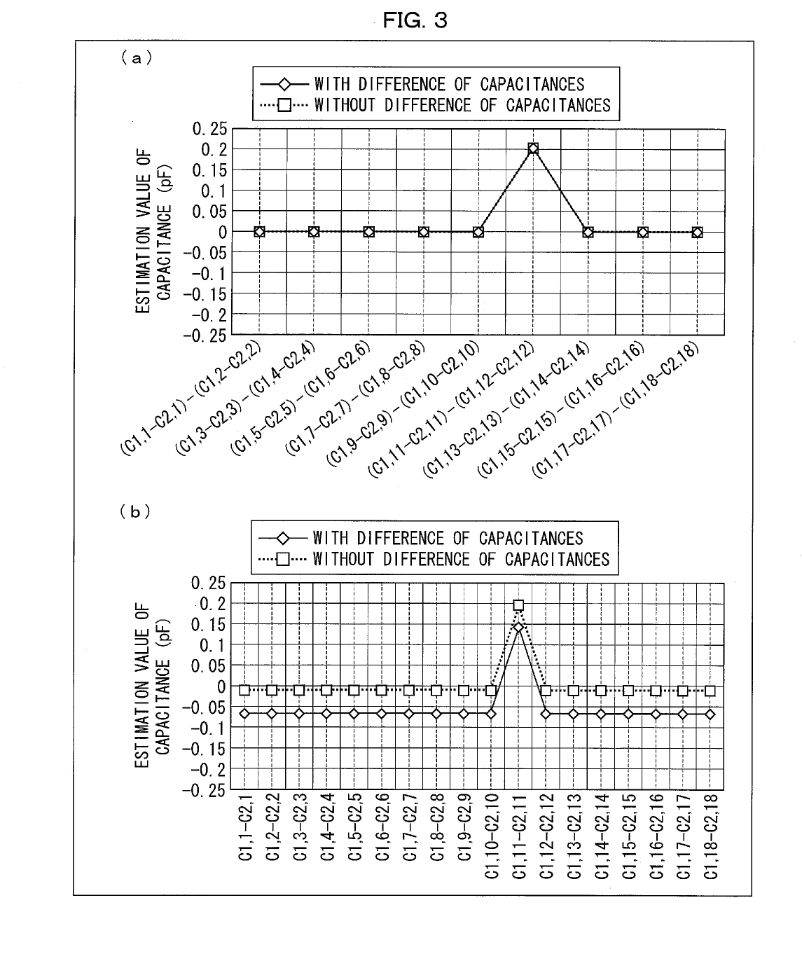

FIG. 3 is a graph indicating one example of estimation values of capacitances calculated by the computation unit 23 when there is a touch input in a vicinity of an intersection of the sense line SL1 and the drive line DL11. A case where the driving unit 14 performs an operation of the present example is illustrated in (a) of the same figure. On the other hand, (b) of the same figure is a comparative example, which indicates a conventional operation in which the driving unit 14 applies a driving voltage corresponding to elements DMt,1 to DMt,18 of the code sequences to the drive lines DL1 to DL18, respectively.

In FIG. 3, the solid line indicates a case where the parasitic capacitance Cp1 of the sense line SL1 is 9 pF and the parasitic capacitance Cp2 of the sense line SL2 is 11 pF as described above. On the other hand, the dotted line indicates a case where both of the parasitic capacitances Cp1 and Cp2 are 10 pF in the comparative example.

In the example indicated in FIG. 3(a), an estimation value of an electrostatic capacitance (C1,11−C2,11)−(C1,12−C2,12) was almost 0.2 pF regardless of a difference between the parasitic capacitances Cp1 and Cp2. On the other hand, an estimation value of a capacitance C1,11−C2,11 changed being dependent on the difference between the parasitic capacitances Cp1 and Cp2 in the comparative example indicated in FIG. 3(b). Thus, the touch panel device 11 of the present embodiment is able to estimate a change in electrostatic capacitances, which is caused by the touch input, correctly.

### (Modified Example)

Note that, in the present embodiment, a driving voltage corresponding to an element of a predetermined code sequence is applied to one of a pair of adjacent drive lines and a driving voltage corresponding to an inversion element obtained by inverting a positive or negative sign of the element is applied to the other, but there is no limitation thereto. For example, the pair of drive lines may not be adjacent and may be separated.

All the drive lines are set as any of the pair of drive lines in the present embodiment, but there is no limitation thereto. For example, a part of drive lines may be any of the pair of drive lines. Since a total value of elements of the code sequence corresponding to driving of the part of drive lines becomes zero in this case as well, an amount of changes in input voltages of the differential amplifier 24 is able to be reduced. Thus, influence of a difference between parasitic capacitances in a pair of sense lines on an output voltage of the differential amplifier 24 is able to be suppressed.

Moreover, it is desired to add a driving voltage based on a predetermined code sequence also for remaining drive lines. In this case, respective electrostatic capacitances formed between the remaining drive lines and the aforementioned sense lines are able to be estimated additionally.

In addition, drive lines at both ends among a plurality of drive lines have different characteristics compared to those of other drive lines in many cases. Thus, all drive lines other than the drive lines at both ends may be any of the pair of drive lines.

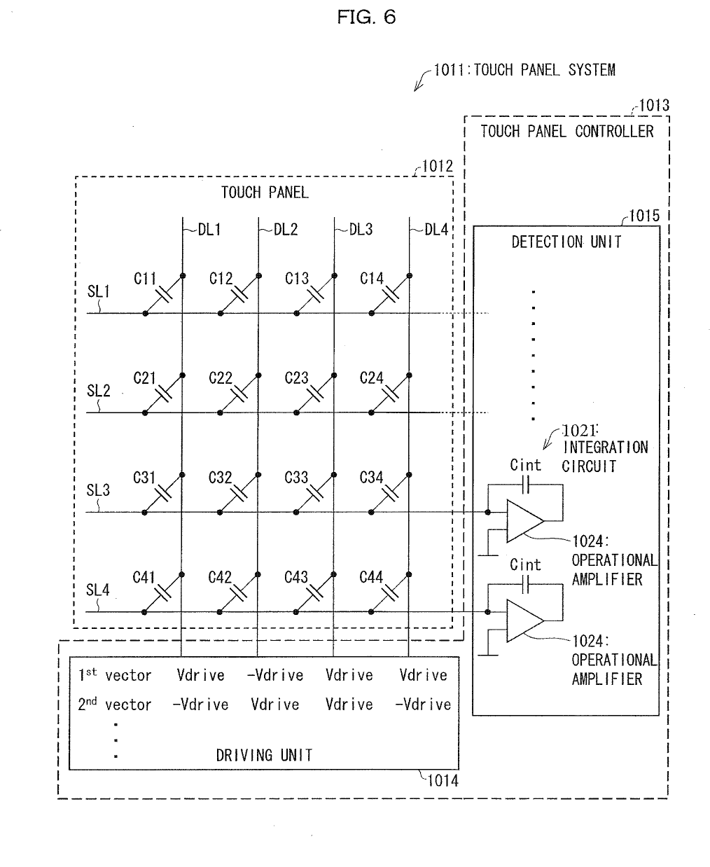

Though the fully-differential amplifier 24 is used in the present embodiment, a standard two-input-one-output differential amplifier may be used or a one-input-one-output operational amplifier as illustrated in FIG. 6 may be used. Further, M-sequences are used as code sequences in the present embodiment, but other code sequences such as Walsh codes, Hadamard codes and Gold sequences may be used.

The touch panel controller 13 may be an integrated circuit in which a logic circuit which functions as the driving unit 14 and the detection unit 15 is formed.

In the present example, code sequences formed of sixty-three M-sequences are used and application of a driving voltage to the drive lines DL1 to DL18 is performed sixty-three times for estimating nine values of (C1,1−C2,1)−(C1,2−C2,2) to (C1,17−C2,17)−(C1,18−C2,18) associated with electrostatic capacitances, but there is no limitation thereto. As long as the application of the driving voltage is performed ten or more times, which is larger than the number of values to be estimated (9), the nine values associated with the electrostatic capacitances are able to be estimated accurately.

That is, when K pair (K is an integer and satisfies 1≦K≦M/2) of drive lines is included in M (M is an integer of 2 or more) drive lines, the number of values to be estimated, which are associated with the electrostatic capacitances, becomes K. Accordingly, as long as the number of times N (N is an integer) of the application of the driving voltage satisfies K<N, the values associated with the electrostatic capacitances are able to be estimated accurately.

On the other hand, when K≧N, the values associated with the electrostatic capacitances are not able to be estimated accurately, but approximate values are able to be estimated. In other words, if the values associated with the electrostatic capacitances do not need to be estimated accurately, the number of times N of the application of the driving voltage may be not more than the number K of the values to be estimated.

### Embodiment 2

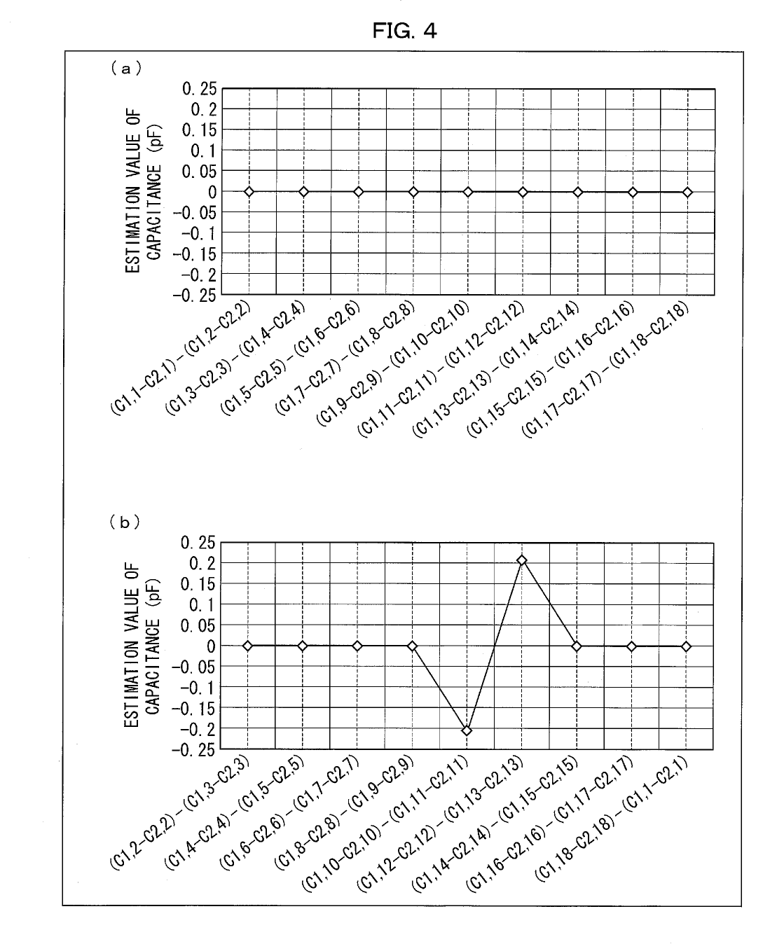

Another embodiment of the invention will be described with reference to FIG. 4. In the example indicated in FIG. 3(a), the computation unit 23 estimates a difference between a difference of the electrostatic capacitances in one of the pair of drive lines and a difference of the electrostatic capacitances in the other. For example, a capacitance estimated by an inner product of an output signal Yt of the differential amplifier 24 and an element DMt,1 of the code sequence corresponding to the drive line DL1 is (C1,1−C2,1)−(C1,2−C2,2).

Here, considered is a case where there is a touch input not only in a vicinity of the intersection of the sense line SL1 and the drive line DL11 like the example indicated in FIG. 3(a), but there is a touch input with the same level also in a vicinity of the intersection of the sense line SL1 and the drive line DL12. In this case, the electrostatic capacitances C2,11 and C2,12 in which there is no touch input have the same value, and the electrostatic capacitances C1,11 and C1,12 also have the same value because of having the same touch input. Accordingly, the capacitance (C1,11−C2,11)−(C1,12−C2,12) estimated by the computation unit 23 becomes zero, so that a touch input is not able to be detected in some cases.

### (Operation of the Present Embodiment)

Thus, the driving unit 14 drives drive lines with a certain code sequence and then drives drive lines with a different code sequence in the present embodiment. For example, in a first set, while applying driving voltages correspond to the elements DMt,1 to DMt,9 of the code sequence to the odd-numbered drive lines DL1 to DL17, respectively, similarly to the example indicated in FIG. 3(a), the driving unit 14 applies driving voltages corresponding to the inversion elements −DMt,1 to −DMt,9 of the elements to the even-numbered drive lines DL2 to DL18, respectively. This processing is iterated from t=1 to t=63 and the computation unit 23 estimates capacitances.

Next, in a second set, while applying the driving voltages corresponding to the elements DMt,1 to DMt,9 of the code sequence to the even-numbered drive lines DL2 to DL18, respectively, the driving unit 14 applies the driving voltages corresponding to the inversion elements −DMt,1 to −DMt,9 of the elements to the odd-numbered drive lines DL3 to DL17 and DL1, respectively. This processing is iterated from t=1 to t=63 and the computation unit 23 estimates capacitances.

### (Example)

FIG. 4 is a graph indicating one example of estimation values of capacitances calculated by the computation unit 23 when there are touch inputs in a vicinity of an intersection of the sense line SL1 and the drive line DL11 and in a vicinity of an intersection of the sense line SL1 and the drive line DL12. Estimation values of capacitances by the first set are indicated in (a) of the same figure and estimation values of capacitances by the second set are indicated in (b) of the same figure.

As indicated in FIG. 4(a), a change in a capacitance is not able to be detected in the first set. As indicated in (b) of the same figure, however, an estimation value of a capacitance (C1,10−C2,10)−(C1,11−C2,11) is −0.207 pF and an estimation value of a capacitance (C1,12−C2,12)−(C1,13−C2,13) is 0.207 pF in the second set. Accordingly, it is recognized that a capacitance C1,11−C2,11 is larger than a capacitance C1,10−C2,10 by 0.207 pF, and a capacitance C1,12−C2,12 is larger than a capacitance C1,13−C2,13 by 0.207 pF.

In addition, it is found from the first set that the capacitance C1,11−C2,11 has the almost same size as the capacitance C1,12−C2,12, so that it is possible to estimate that there are changes in capacitances by 0.207 pF in the vicinity of the intersection of the sense line SL1 and the drive line DL11 and in the vicinity of the intersection of the sense line SL1 and the drive line DL12.

### (Modified Example)

Note that, the driving unit 14 performs driving of the first set and the computation unit 23 estimates a capacitance, and then, the driving unit 14 performs driving of the second set and the computation unit 23 estimates a capacitance in the present embodiment, but there is no limitation thereto. For example, it may be such that the driving unit 14 performs driving of the first set and subsequently performs driving of the second set, and then, the computation unit 23 estimates a capacitance by the driving of the first set and subsequently estimates a capacitance by the driving of the second set. Moreover, two types of code sequences are used in the present embodiment, but without limitation thereto, three or more types of code sequences may be used.

### Embodiment 3

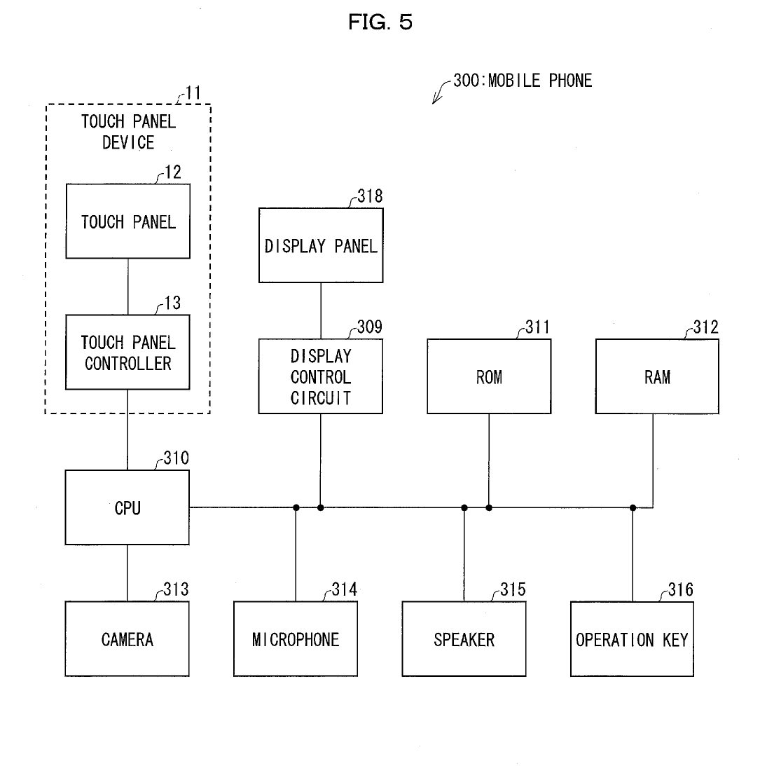

Another embodiment of the invention will be described with reference to FIG. 5. FIG. 5 is a block diagram illustrating a schematic configuration of a mobile phone according to the present embodiment. A mobile phone (electronic device) 300 according to the present embodiment includes the touch panel device 11 of any of the first embodiment and the second embodiment.

### (Configuration of Mobile Phone)

The mobile phone 300 according to the present embodiment is composed to include, as illustrated in FIG. 5, the touch panel device 11, a CPU (Central Processing Unit) 310, a ROM (Read Only Memory) 311, a RAM (Random Access Memory) 312, a camera 313, a microphone 314, a speaker 315, an operation key 316, a display control circuit 317 and a display panel 318. Respective components of the mobile phone 300 are mutually connected by a data bus.

The touch panel device 11 includes the touch panel 12 and the touch panel controller 13 similarly to the touch panel device 11 illustrated in FIG. 1.

The CPU 310 integrally controls an operation of the mobile phone 300. The CPU 310 controls the operation of the mobile phone 300, for example, by executing a program stored in the ROM 311.

The ROM 311 is a readable and unwritable memory, for example, such as an EPROM (Erasable Programmable Read-Only Memory), which stores fixed data such as a program to be executed by the CPU 310.

The RAM 312 is a readable and writable memory, for example, such as a flash memory®, which stores data to be referred to for computation by the CPU 310 and variable data such as data generated by the CPU 310 with computation.

The operation key 316 receives an input of an instruction by a user to the mobile phone 300. Data input through the operation key 316 is stored in the RAM 312 in a volatile manner.

The camera 313 photographs an object based on a photographing instruction input by the user through the operation key 316. Image data of the object photographed by the camera 313 is stored in the RAM 312, an external memory (for example, a memory card) or the like.

The microphone 314 receives an input of a voice of the user. Voice data indicating the input voice of the user (analog data) is converted into digital data in the mobile phone 300 and sent to another mobile phone (communication partner).

The speaker 315 outputs a sound represented by music data stored, for example, in the RAM 312 or the like.

The display control circuit 317 drives the display panel 318 so as to display an image represented by image data, which is stored in the ROM 311, the RAM 312 or the like, based on a user instruction input through the operation key 316. The display panel 318 may be provided being overlapped with the touch panel 12 or may incorporate the touch panel 12, and a configuration thereof is not particularly limited.

Further, the mobile phone 300 may further include an interface (IF) (not illustrated) for connection with other electronic device in a wired manner.

The mobile phone 300 according to the present embodiment is able to execute estimation of electrostatic capacitances more correctly than before by including the touch panel device 11. Thereby, the mobile phone 300 is able to recognize a touch operation by a user more correctly than before, thus making it possible to execute processing desired by the user more correctly than before.

### (Modified Example)

Note that, though the invention is applied to a mobile phone in the present embodiment, the invention is also applicable to other electronic devices such as a smartphone, a tablet terminal, a fingerprint detection system, an ATM (automatic teller machine).

Further, the computation unit 23 in the touch panel controller 13 may be omitted. In this case, the computation unit 23 may be provided between the touch panel device 11 and the CPU 310. Alternatively, a program stored in the ROM 311 may be merely caused to execute computation processing in the computation unit 23 on the CPU 310.

### [Summary]

A touch panel controller according to an aspect 1 of the invention is a touch panel controller which controls a touch panel having M (M is an integer of 2 or more) electrostatic capacitances formed between M drive lines and a sense line, including: a driving unit which performs N (N is an integer) time of driving for applying a driving voltage based on a predetermined code sequence represented by N K-dimensional vector to one drive line of each of K (K is an integer and satisfies 1≦K≦M/2) pair of drive lines, and applying a driving voltage obtained by inverting a polarity of the driving voltage to the other drive line of each pair of drive lines; and a detection unit which detects a linear sum of amounts of charges accumulated in the sense line by the driving voltages and the electrostatic capacitances and outputs a linear sum signal based on the linear sum N time.

With the aforementioned configuration, the driving unit applies the driving voltage based on the code sequence represented by the N K-dimensional vectors to one of the K pair of drive lines and applies an inversion voltage obtained by inverting the polarity of the driving voltage to the other, in the N-time of driving. This makes it possible to suppress a voltage in the sense line. Thus, it is possible to suppress an amount of charges accumulated by a parasitic capacitance in the sense line. As a result thereof, since each of the K differences of the respective electrostatic capacitances in the K pair of drive lines is able to be estimated accurately by computation of the inner product of the N linear sum signals from the detection unit and the code sequence, thus making it possible to estimate an amount of change in the electrostatic capacitances accurately.

As one example of the predetermined code sequence, there are an M-sequence, a Walsh code, a Hadamard code, a Gold sequence and the like. The drive lines in the pair may be or may not be adjacent.

The integer N desirably satisfies K<N. In this case, each of the K differences is able to be estimated accurately. Note that, if the accuracy is not desired, the integer N may satisfy K≧N.

A driving voltage based on a predetermined code sequence represented by an N (M−2K)-dimensional vector is desirably applied also to (M−2K) drive lines other than the K pair of drive lines. In this case, it is possible to further estimate each (M−2K) electrostatic capacitance formed between the (M−2K) drive lines and the sense line.

All the M drive lines are desirably set in the pair of drive lines. In this case, a voltage in the sense line, which is caused by application of the driving voltage, is able to be suppressed to zero. Accordingly, the amount of charges accumulated by the parasitic capacitance in the sense line is able to be suppressed to zero, resulting that the amount of changes in the electrostatic capacitances is able to be estimated more accurately.

Meanwhile, drive lines at both ends among the M drive lines are likely to have different characteristics compared to those of other drive lines. Thus, the (M−2) drive lines other than the drive lines at both ends may form the pair of drive lines.

Meanwhile, in the case of the invention, a difference between two of the electrostatic capacitances at positions of two intersections of the pair of drive lines and the sense line is to be estimated. Therefore, even when a touch is performed at the positions of the two intersections, the two of the electrostatic capacitances have the same amount of changes caused by the touch, so that the difference between the two electrostatic capacitances does not change and the touch is not able to be detected in some cases.

Thus, it is desirable in a touch panel controller according to an aspect 2 of the invention that the driving unit performs the N-time of driving for a plurality of sets, and at least one drive line is different between in the pair of drive lines for at least one set of the plurality of sets and in the pair of drive lines for the other set, in the aspect 1. In this case, the difference does not change in a certain set of the plurality of sets but changes in the other set, thus making it possible to detect the touch. Accordingly it is possible to avoid deterioration in detection accuracy of the touch.

An integrated circuit according to an aspect 3 of the invention may be an integrated circuit which functions as the touch panel controller according to the aspect 1 or 2, in which a logic circuit which functions as each of the units is formed. In this case as well, the effect similar to the above is able to be achieved.

A touch panel device according to an aspect 4 of the invention may be an electronic device including the touch panel controller according to the aspect 1 or 2. In this case as well, the effect similar to the above is able to be achieved.

Note that, the electronic device may be a touch panel device including a touch panel controlled by the touch panel controller. Further, in the electronic device, a display panel overlapped with a touch panel or incorporating the touch panel in the touch panel device may be further included.

It is desirable that an electronic device according to an aspect 5 of the invention further includes an estimation unit which estimates K differences of respective electrostatic capacitances in the K pair of drive lines by computation of an inner product of the N linear sum signal from the detection unit and the code sequence, in the aspect 4. In this case, the electronic device is able to estimate an amount of changes in the electrostatic capacitances accurately by the estimation unit. Note that, the estimation unit may be provided inside the touch panel controller or may be provided outside the touch panel controller. Alternatively, when the electronic device includes a CPU and a memory, a function of the estimation unit may be realized by executing a program, which is stored in the memory, by the CPU.

The invention is not limited to each of the embodiments described above and can be modified variously within the scope defined by the claims, and embodiments obtained by appropriately combining technical means disclosed in different embodiments are also included in the technical scope of the invention. Further, by combining the technical means disclosed in each of the embodiments, a new technical feature may be formed.

### INDUSTRIAL APPLICABILITY

The invention is able to be used for a touch panel controller which applies a driving voltage based on a predetermined code sequence to each of a plurality of drive lines to thereby detect each linear sum of amounts of charges accumulated in sense lines, and estimates capacitances between the plurality of drive lines and a plurality of sense lines by using amounts of charges detected a plurality of times by a plurality of times of application and the predetermined code sequence, and for a touch panel device and an electronic device which use the same.

### REFERENCE SIGNS LIST

11 touch panel device (electronic device)

12 touch panel

13 touch panel controller

14 driving unit

15 detection unit

21 integration circuit

22 A/D conversion unit

23 computation unit (estimation unit)

24 differential amplifier

25 capacitive element

300 mobile phone (electronic device)

310 CPU

311 ROM

312 RAM

313 camera

314 microphone

315 speaker

316 operation key

317 display control circuit

318 display panel

1. A touch panel controller which controls a touch panel having M (M is an integer of 2 or more) electrostatic capacitances formed between M drive lines and a sense line, comprising:
a driving unit which performs N (N is an integer) time of driving for applying a driving voltage based on a predetermined code sequence represented by N K-dimensional vector to one drive line of each of K (K is an integer and satisfies 1≦K≦M/2) pair of drive lines and applying a driving voltage obtained by inverting a polarity of the driving voltage to the other drive line of each pair of drive lines; and
a detection unit which detects a linear sum of amounts of charges accumulated in the sense line by the driving voltages and the electrostatic capacitances and outputs a linear sum signal based on the linear sum N time.
wherein the driving unit performs the N-time of driving for a plurality of sets, and at least one drive line is different between in the pair of drive lines for at least one set of the plurality of sets and in the pair of drive lines for the other set.

2. (canceled)

3. An integrated circuit which functions as the touch panel controller according to claim 1, wherein a logic circuit which functions as each of the units is formed.

4. An electronic device comprising the touch panel controller according to claim 1.

5. The electronic device according to claim 4, further comprising an estimation unit which estimates K differences of respective electrostatic capacitances in the K pair of drive lines by computation of an inner product of the N linear sum signal from the detection unit and the code sequence.
